(19) United States
(12) Patent Application Publication
(10) Pub. No.: US 2007/0189332 A1
(43) Pub. Date: Aug. 16, 2007

(54) Apparatus, method and computer program product providing in-band signaling and data structures for adaptive control and operation of segmentation

(75) Inventors: Vinh Van Phan, Oulu (FI); Tsuyoshi Kashima, Yokohama (JP); Kimmo Kettunen, Espoo (FI); Jukka Ranta, Kaarina (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/706,037

(22) Filed: Feb. 13, 2007

Related U.S. Application Data
(60) Provisional application No. 60/773,208, filed on Feb. 13, 2006.
(60) Provisional application No. 60/773,402, filed on Feb. 14, 2006.

(51) Int. Cl. H04J 3/24

(52) U.S. Cl. 370/474

(57) ABSTRACT

Apparatus, methods, computer program products and data structures are provided that enable effective in-band signaling and data structures for adaptive control and operation of segmentation. An exemplary method includes: determining, during an ongoing wireless communication, that a current communication scheme is to be changed to a new communication scheme including one of a new segmentation scheme or a new non-segmentation scheme; and sending a control protocol data unit (C-PDU) from a first device to a second device, wherein the C-PDU includes identification information identifying the new communication scheme and control information related to the new communication scheme.

### CROSS-REFERENCE TO RELATED APPLICATIONS

This patent application claims priority under 35 U.S.C. §119(e) from Provisional Patent Application No. 60/773,208, filed Feb. 13, 2006, and from Provisional Patent Application No. 60/773,402, filed Feb. 14, 2006, the disclosures of which are incorporated by reference herein in their entirety.

### TECHNICAL FIELD

The exemplary embodiments of this invention relate generally to wireless communications systems, methods and devices and, more specifically, relate to techniques for operating a user equipment, such as a cellular phone, with a wireless network.

### BACKGROUND

The following abbreviations are herewith defined:

3GPP third generation partnership project

AM acknowledge mode

AMC adaptive modulation and coding

BS base station

DCH dedicated transport channel

DL downlink (Node B to UE)

E-UTRAN evolved UTRAN

H-ARQ hybrid automatic request/acknowledge

HSPA high speed packet access

HSUPA high speed uplink packet access

IP internet protocol

L1 layer 1 (physical (PHY) layer)

L2 layer 2 (link layer)

LCID logical channel identifier

LTE long term evolution of UTRAN

MAC medium access control

Node B base station

OFDMA orthogonal frequency division multiple access

PDU protocol data unit

QOS quality of service

QPSK quadrature phase shift keying

RACH random access channel

RF radio frequency

RRC radio resource control

SC-FDMA single carrier-frequency division multiple access

SCH shared transport channel

SDU service data unit

SN sequence number

TB transport block

TTI transmission time interval

UE user equipment, such as a mobile station or mobile terminal

UL uplink (UE to Node B)

UM unacknowledge mode

UMTS universal mobile telecommunications system

UTRA UMTS terrestrial radio access

UTRAN UMTS terrestrial radio access network

VoIP voice over IP

Of particular interest to the exemplary embodiments of this invention are modem cellular networks, such as one referred to as UTRA LTE in 3GPP UMTS. Modern cellular networks may employ multi-carrier technologies such as OFDMA in the DL and SC-FDMA in the UL, and various advanced radio transmission techniques such as AMC and H-ARQ. The radio interface relies on the presence of a SCH in both the UL and DL with fast adaptive resource allocation for simple and efficient radio resource utilization and QoS support, and no longer uses a DCH. The spectrum flexibility requirement of E-UTRAN suggests that the system should be capable of operation in spectrum allocations of different sizes, including 1.25 MHz, 2.5 MHz, 5 MHz, 10 MHz, 15 MHz and 20 MHz, in both the UL and DL.

Details of this particular type of system may be found in 3GPP TR25.913 V7.2.0 (2005-12), Requirements for Evolved UTRA (E-UTRA) and Evolved UTRAN (E-UTRAN), which is incorporated by reference herein in its entirety.

For the transmission of data packets, in particular IP packets, over the radio interface, the link layer (L2) of the radio interface, including the MAC functionality, is responsible for segmenting IP-based SDUs passed down by an upper layer into one or several segments and, at the same time, packing one or multiple segments into a PDU for further physical layer (L1) transmission. These two processes, L2 SDU segmentation and L2 PDU packing, although seemingly contradictory and capable of generating significant protocol overhead, are both needed to ensure robust transmission of IP packets with variable packet sizes in bits or bytes over erratic radio channels with variable bit rates.

Furthermore, L2 retransmissions using an ARQ protocol operating on a L2 SDU, or segments thereof, with a packet sequence number can be used, in addition to a HARQ at a lower level, to ensure a reliable, in-order L2 transmission.

Reference with respect to an intelligent TB size determination method and a flexible segmentation scheme (e.g., for retransmission) may be made to commonly assigned U.S. patent application Ser. No. ___/____, filed Jan. 4, 2007, entitled “A Flexible Segmentation Scheme For Communications Systems”, by Tsuyoshi Kashima, Mika Rinne, Jukka Ranta and Paivi Purovesi (Attorney's Docket No. 897A.0026.U1(US)).

### SUMMARY

In an exemplary aspect of the invention, a method is provided, including: determining, during an ongoing wireless communication, that a current communication scheme is to be changed to a new communication scheme including one of a new segmentation scheme or a new non-segmentation scheme; and sending a control protocol data unit (C-PDU) from a first device to a second device, wherein the C-PDU includes identification information identifying the new communication scheme and control information related to the new communication scheme.

In another exemplary aspect of the invention, a computer program product is provided. The computer program product includes program instructions embodied on a tangible computer-readable medium. Execution of the program instructions results in operations including: determining, during an ongoing wireless communication, that a current communication scheme is to be changed to a new communication scheme including one of a new segmentation scheme or a new non-segmentation scheme; and sending a control protocol data unit (C-PDU) from a first device to a second device, wherein the C-PDU includes identification information identifying the new communication scheme and control information related to the new communication scheme.

In a further exemplary aspect of the invention, an electronic device is provided, including: a transceiver configured to wirelessly communicate with another electronic device; and a data processor coupled to the transceiver, wherein the data processor is configured to determine, during an ongoing wireless communication with a second device, that a current communication scheme is to be changed to a new communication scheme comprising one of a new segmentation scheme or a new non-segmentation scheme; and sending a control protocol data unit (C-PDU), using the transceiver, to the second device, wherein the C-PDU comprises identification information identifying the new communication scheme and control information related to the new communication scheme.

In another exemplary aspect of the invention, a protocol data unit structure is provided, including: D/C information configured to indicate that the protocol data unit structure includes a control protocol data unit (C-PDU); new scheme identification configured to indicate a new communication scheme for ongoing wireless communication, wherein the new communication scheme is one of a new segmentation scheme or a new non-segmentation scheme; and a control payload including control information for the new communication scheme.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a simplified block diagram of various electronic devices that are suitable for use in practicing the exemplary embodiments of this invention;

FIG. 2 depicts a logic flow diagram in accordance with an aspect of the exemplary embodiments of this invention;

FIG. 3 depicts a logic flow diagram in accordance with a further aspect of the exemplary embodiments of this invention;

FIG. 4 illustrates one suitable embodiment of basic data flow at the MAC layer;

FIG. 5 illustrates an overview of the MAC structure;

FIG. 6 illustrates Transport Block (TB) for Acknowledge Mode (AM) and Unacknowledge Mode (UM);

FIG. 7 shows a MAC C-PDU for SCH;

FIG. 8 shows a MAC D-PDU;

FIG. 9 shows a MAC segment in accordance with a first case (Case 1) for post-segmentation operation;

FIG. 10 shows a MAC segment in accordance with a second case (Case 2) for non-segmentation operation;

FIG. 11 shows a MAC segment in accordance with a third case (Case 3) for pre-segmentation operation;

FIGS. 12 and 13 illustrate exemplary and non-limiting embodiments of C-PDUs in accordance with the exemplary embodiments of this invention, specifically a C-PDU for adaptive control of segmentation and a C-PDU for acknowledging receipt of the C-PDU for adaptive control of segmentation, respectively; and

FIG. 14 depicts a flowchart illustrating one non-limiting example of a method for practicing the exemplary embodiments of this invention.

### DETAILED DESCRIPTION

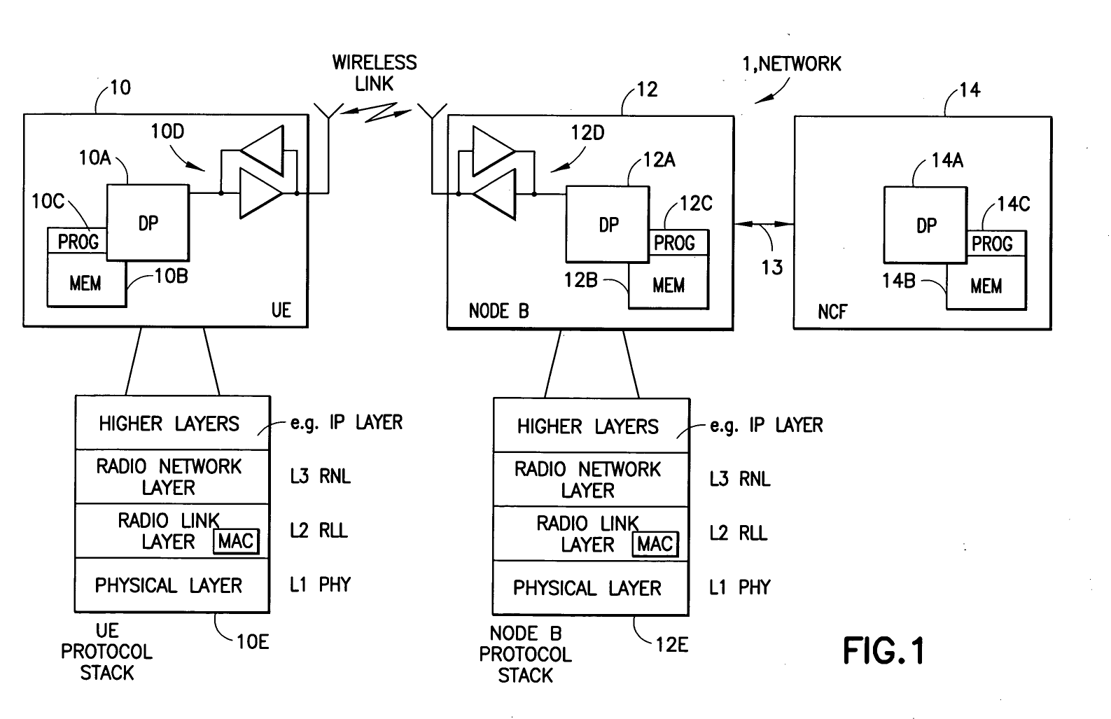

Reference is made first to FIG. 1 for illustrating a simplified block diagram of various electronic devices that are suitable for use in practicing the exemplary embodiments of this invention. In FIG. 1, a wireless network 1 is adapted for communication with a UE 10 via a Node B (base station) 12. The network 1 may include at least one network control function (NCF) 14. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is coupled via a data path 13 to the NCF 14 that also includes a DP 14A and a MEM 14B storing an associated PROG 14C. At least the PROGs 10C and 12C are assumed to include program instructions that, when executed by the associated DP, enable the electronic device to operate in accordance with the exemplary embodiments of this invention, as will be discussed below in greater detail.

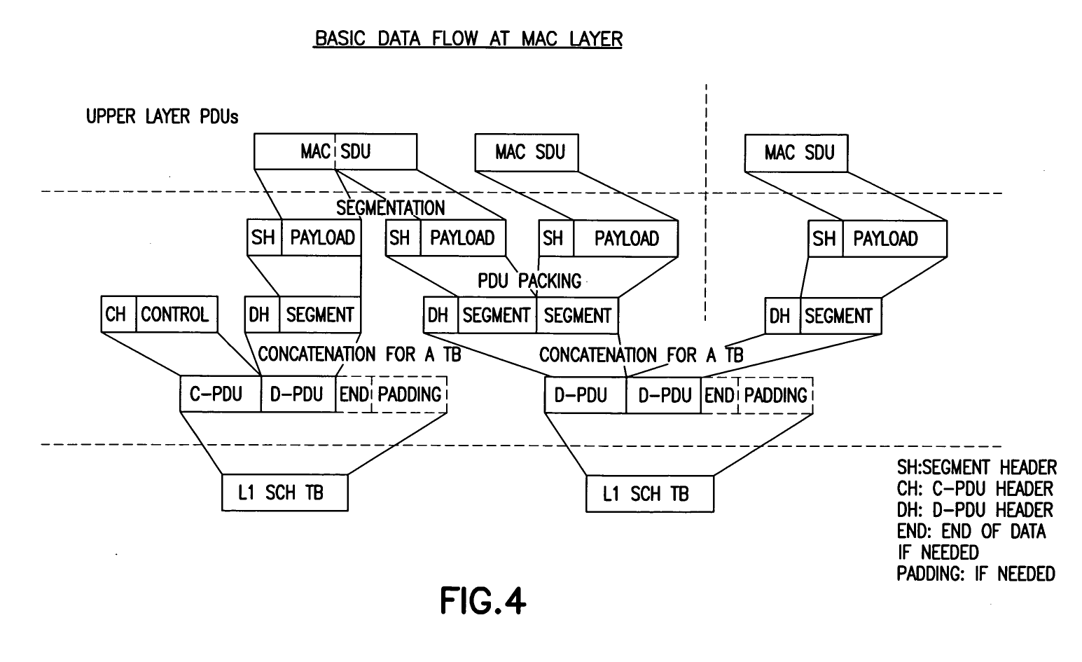

The UE 10 is assumed to include and implement a protocol stack 10E containing at least layers L1 (PHY, Physical), L2 (RLL, Radio Link Layer, containing the MAC functionality) and L3 (RNL, Radio Network Layer), and typically higher layers as well (e.g., an IP layer). The Node B 12 is assumed to include and implement a protocol stack 12E also containing at least layers L1 (PHY), L2 (RLL) and L3 (RNL), and typically also the higher layers as well (e.g., an IP layer). FIG. 4 illustrates one suitable and non-limiting embodiment of basic data flow at the MAC layer.

In general, the various embodiments of the UE 10 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

The exemplary embodiments of this invention are related to the embodiments of the invention disclosed in commonly owned U.S. Provisional Patent Application 60/773,211, filed on Feb. 13, 2006, entitled “Apparatus, Method and Computer Program Product Providing Smart Selection of L2 Packet Segmentation and Retransmission Adapted to Flexible System Bandwidth for E-UTRAN”, by Vinh Van Phan, Tsuyoshi Kashima and Kimmo Kettunen (Attorney's Docket No. 897A.0033.P1(US)), which is incorporated by reference herein in its entirety. Before discussing the exemplary embodiments of the present invention, the following introductory description is presented in the context of the above-captioned commonly owned U.S. Provisional Patent Application.

In the current development of L2 concepts for E-UTRAN, several options for MAC protocol structures and functions, including segmentation and retransmission, may be considered. In general, these options differ in the area of SDU segmentation.

A first option follows a more or less similar approach as used in the current HSPA in UTRAN, wherein semi-static segmentation sizes for certain logical channels are used, and where segments may have a fixed size or a fixed size limit that is adjusted according to user-specific characteristics and averaged radio conditions. The size limitation implies a possible case in which only SDUs that have a size exceeding the size limit are segmented and, otherwise, a variable segment size is allowed.

One potential drawback to this approach is that the segmentation setting is preferably made somewhat conservative (the segment size is set to a small, conservative value) and, therefore, the performance in terms of protocol overhead and effective throughput can be reduced. A clear benefit to the use of this approach is that segmentation can be performed beforehand and independently from the packet scheduling and L1 operation. This reduces complexity and saves running time for other related processes that need to be executed within the required TTI (interleaving interval of a TB).

A second option proposes a dynamic, on-the-fly segmentation per TTI. In this approach, any required segmentation is performed after the scheduling decision is made, and the available TB size has been determined. Reference with respect to “A Flexible Segmentation Scheme For Communications Systems” may be made to the above-referenced commonly assigned U.S. patent application Ser. No.___/___, Rinne et al., Attorney's Docket No. 897A.0026.U1(US)).

A potential drawback to the use of this approach is the more stringent processing time budget for required L1-L2 operations within a TTI. A benefit of this approach is that the segmentation can be optimized for the available TB size, thereby minimizing protocol overhead and the processing load of performing unnecessary segmentation operations.

A consideration is now made of several comparative examples that will serve to place into context the benefits of the use of the exemplary embodiments disclosed in the above-captioned commonly owned U.S. Provisional Patent Application (No. 60/773,211, Phan et al., Attorney's Docket No. 897A.0033.P1(US)). The current HSPA of UTRAN is used as the reference due to the fact that E-UTRAN system requirements, as described in TR25.913, also use UTRAN HSPA as the main reference. In general, however, the exemplary embodiments disclosed in the above-captioned commonly owned U.S. Provisional Patent Application do not rely on the presence or use of UTRAN HSPA.

UTRAN HSPA employs, in a general sense, the first option discussed above. It is noted in this regard that the minimum TTI in the current HSPA of UTRAN is 2 ms, whereas in E-UTRAN the TTI is proposed to be 1 ms. This means that, assuming the same available TB size, the scheduled data rate in E-UTRAN should be about twice that of HSPA. The potential gain of the second option, in terms of reducing protocol overhead, is more notable if the available TB size in E-UTRAN is made larger than that of the HSPA counterpart, that is, the scheduled data rate for a user at any given time can be greater than about twice that of HSPA. This is foreseeable only when the system bandwidth available for E-UTRAN operation is at least the same as for UTRAN, i.e., 5 MHz, as E-UTRAN has a higher spectrum efficiency requirement.

Considering now additional numerical examples, consider a case of E-UTRAN where the scheduled data rate for a TTI is about 2Mbps (million bits per second). Thus, the TB size is about 2000bits (assuming a TTI=1 ms), which is not much greater than what can be set for the MAC PDU size of the DCH transmitted over HS-DSCH. In this case, the gain derived from the use of the second option is not particularly significant. In another case, E-UTRAN operates in a 1.25 MHz system bandwidth with ½ coding rate and QPSK modulation. In this case there are only 900 information bits available for a TTI of one sub-frame duration (1 ms). A typical large IP packet has a length of about 1500 bytes=12000 bits, and such an IP packet will need to be segmented into at least 12 MAC segments. In these exemplary examples, and depending on the platform capabilities, it can be seen that the first option, with semi-static segmentation size setting, can be more feasible and practical to implement. Note that although presented in the above non-limiting examples as specific values, the actual number of information bits may depend on other characteristics, such as the frame format (which is currently unspecified in E-UTRAN), as a non-limiting example.

It can be noted that, in addition to the two options described above, the optimization of TB size for given user traffic characteristics (e.g., MAC SDU sizes, arrival and serving patterns, etc.) may result in similar efficiency gains related to system performance. However, this is generally considered to be an element of optimized packet-scheduling design, which has a larger scope and requires much more processing and complexity than the problems addressed and the solutions provided by the exemplary embodiments disclosed in the above-captioned commonly owned U.S. Provisional Patent Application.

Hence, considering the various tradeoffs between simplicity and efficiency that are considered by the two options discussed above, the exemplary embodiments disclosed in the above-captioned commonly owned U.S. Provisional Patent Application (No. 60/773,211) provide an ability to make selective use, in an informed manner, of these options as they relate to L2 packet segmentation and retransmission. An aspect of the use of the exemplary embodiments disclosed in the above-captioned commonly owned U.S. Provisional Patent Application is an adaptation to the configurable and flexible spectral bandwidth of the system.

It should be noted that the MAC PDU structures can be designed for each of the above options, and in such a way that allows for both of the above options to be used without any modification.

In accordance with the exemplary embodiments disclosed in the above-captioned commonly owned U.S. Provisional Patent Application, the spectral bandwidth of the system is constrained to the spectrum flexibility requirement as currently specified in 3GPP TR25.913 Section 8.2, which currently includes: a) support for spectrum allocations of different sizes such as 1.25 MHz, 2.5 MHz, 5 MHz, 10 MHz, 15 MHz and 20 MHz in both the UL and the DL; and b) support for diverse spectrum arrangements.

More specifically, 3GPP TR25.913 v7.2.0 (December 2005) Section 8.2, Spectrum Flexibility states:

a) Support for spectrum allocations of different size

1) E-UTRA shall operate in spectrum allocations of different sizes, including 1.25 MHz, 2.5 MHz, 5 MHz, 10 MHz, 15 MHz and 20 MHz. in both the uplink and downlink. Operation in paired and unpaired spectrum shall be supported.
2) Unnecessary fragmentation of technologies for paired and unpaired band operation shall be avoided. This shall be achieved with minimal additional complexity.
   b) Support for diverse spectrum arrangements
1) The system shall be able to support (same and different) content delivery over an aggregation of resources including Radio Band Resources (as well as power, adaptive scheduling, etc) in the same and different bands, in both uplink and downlink and in both adjacent and non-adjacent channel arrangements.
2) The degree to which the above requirement is supported is conditioned on the increase in UE and network complexity and cost.
3) A “Radio Band Resource” is defined as all spectrum available to an operator.

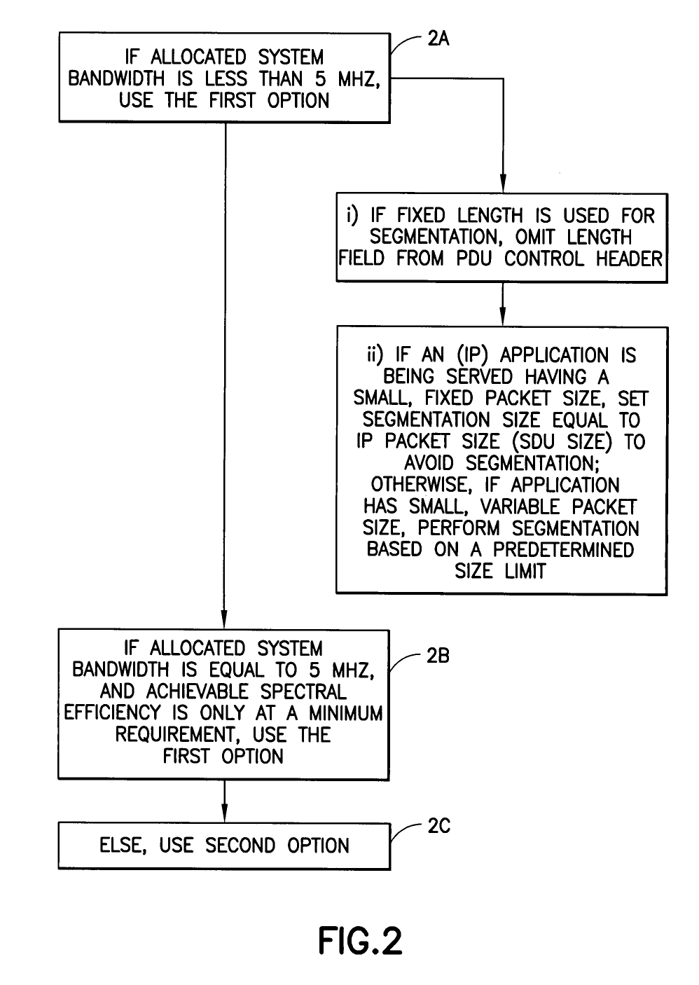

In accordance with the exemplary embodiments disclosed in the above-captioned commonly owned U.S. Provisional Patent Application, and depending on the system bandwidth allocation and the achievable spectral efficiency, either the first option or the second option discussed above are adopted for use. For example, and referring to the logic flow diagram of FIG. 2:

Block 2A. If the allocated system bandwidth is less than 5 MHz, use the first option (semi-static segmentation sizes);

i.) in a case where a fixed length is used for segmentation, a length field is omitted from a control header (CH) of PDUs;

ii.) in a case where IP-based applications, such as VoIP, are being served, i.e., those having fixed and relatively small packet sizes, the segmentation size is set to be the same as the IP packet size (e.g., SDU size) thereby avoiding actual segmentation; otherwise, when IP applications have relatively small, but variable, packet sizes, the segmentation is performed using the pre-determined segment size. The segment size can be semi-statically controlled and optimized by the control function based on the application characteristics.

Block 2B. If the allocated system bandwidth is equal to 5 MHz, and the achievable spectral efficiency is only a minimum requirement, that is, about two times greater than that of HSPA in UTRAN, use the first option (semi-static segmentation sizes).

Block 2C. Otherwise, use the second option (dynamic segmentation per TTI).

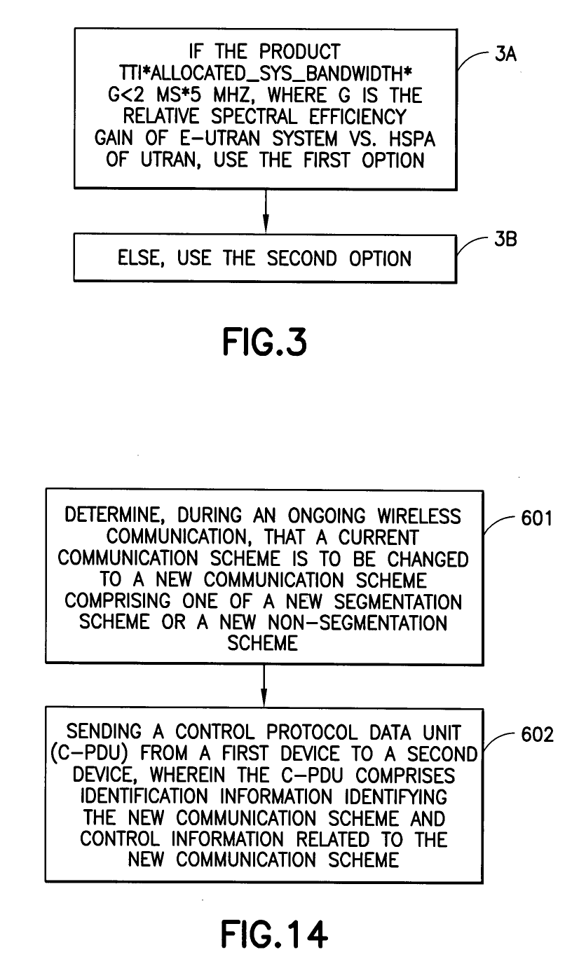

In addition, for a case that considers more generic system conditions such as that the system allows a more flexible length of the TTI as an interleaving interval of a TB (note that the above discussion has assumed a rather short TTI of about one millisecond), or that the system spectral efficiency need not be exactly four times greater than HSPA, the criteria for choosing segmentation options may be, as non-limiting examples, as follows (see FIG. 3):

Block 3A. If the product TTI*Allocated_System_Bandwidth*G is less than 2 ms*5 MHz, where G is the relative spectral-efficiency gain of the E-UTRAN system vs. HSPA of UTRAN taking a value between two and four as required in 3GPP TR25.913, use the first option (semi-static segmentation sizes);

Block 3B. Else, use the second option (dynamic segmentation per TTI).

To further reduce complexity, while still maintaining adequate efficiency when possible, the exemplary embodiments disclosed in the above-captioned commonly owned U.S. Provisional Patent Application also provide for the possibility of omitting segmentation altogether when the scheduled bandwidth exceeds 10MHz or, more generally, when the scheduled TB size is foreseen as being much larger than the maximum SDU size. Note in this regard that the TB size in E-UTRAN can be up to tens of thousands of bits and, typically, the IP-based maximum SDU size is about 12,000 bits.

The exemplary embodiments disclosed in the above-captioned commonly owned U.S. Provisional Patent Application also provide for the possibility of making optional the use of the length indicating field and the position-offset indicating field that are included in the control header of a MAC SDU segment (which are needed for segmentation control and operation). These can be omitted in the case that the first option with a fixed segment size is selected, but also considering whether it is the first, intermediate or last segment of a SDU and/or whether padding is needed. The fixed segment size, in that case, is assumed to be signaled between the transmitter and the receiver beforehand. The sequence number field in the segment header needed for segmentation control and ARQ operation, in the first option with pre-segmentation, may also be mutually understood by the transmitter and the receiver as a segment sequence number (otherwise defined as the SDU sequence number).

Additional details regarding the signaling of information and data structures related to the MAC SDUs in E-UTRAN systems to support the aforementioned exemplary embodiments disclosed in the above-captioned commonly owned U.S. Provisional Patent Application are described in greater detail below in regards to the exemplary embodiments in accordance with the present invention.

The exemplary embodiments disclosed in the above-captioned commonly owned U.S. Provisional Patent Application allow for a most efficient hardware and software implementation of the advanced features for E-UTRAN, and also provide a selection mechanism that is amenable to standardization in regard to L2 segmentation and data structure design.

Note further that the use of the exemplary embodiments disclosed in the above-captioned commonly owned U.S. Provisional Patent Application do not require any significant changes in existing structures and procedures of the radio interface and, in particular, of L2.

In addition, the use of the exemplary embodiments disclosed in the above-captioned commonly owned U.S. Provisional Patent Application may employ signaling of certain L2 configuration parameters (e.g., information concerning SDU size, segmentation size, and/or the segmentation size limit), and the receipt and interpretation of certain cell configuration parameters at the UE 10 via, e.g., broadcast system information such as, but not limited to, operating system bandwidth(s).

Having thus described the exemplary embodiments disclosed in the above-captioned commonly owned U.S. Provisional Patent Application, a description is now made of the exemplary embodiments of the present invention.

As should be apparent at this point, practical techniques for adaptive MAC packet segmentation and transmission depending, for example, on the size of the allocated system bandwidth in MHz, TTI and spectrum efficiency are disclosed in the exemplary embodiments disclosed in the above-captioned commonly owned U.S. Provisional Patent Application. This is subject to an optimal trade-off between simplicity and efficiency in system design and performance. The disclosed techniques include the pre-segmentation approach, in which all the segmentation is done beforehand and independently from the packet scheduling and L1 operation in a semi-static fashion, and the post-segmentation approach, in which the segmentation is done per TTI on a necessity basis optimized for an allowed TB size. The allowed TB size is preferably large and determined after the scheduling and allocation decision is made for the current TTI.

Viewed in another way, the adaptive operation of MAC, in particular MAC segmentation functions, may be optimized for a certain type of traffic, application or service such as VoIP. This type of traffic typically exhibits a small, fixed or variable, packet size and in general should preferably not be MAC segmented for achieving efficient transmission over the radio interface SCH. This particular case can be referred to as the non-segmentation approach.

Furthermore, considering simplicity-efficiency tradeoffs for the operation of an outer ARQ, an issue that arises is whether the L2 outer ARQ should operate on complete upper-layer SDUs or segments thereof. The latter is recommended for the pre-segmentation case at least and the former is considered for the post-segmentation and non-segmentation cases. This may have an impact on the design and use of packet sequence numbers in MAC data structures for counting and in-sequence ordering either MAC SDUs or SDU segments.

The exemplary embodiments of this invention provide unified, simple and effective in-band signaling and data structures for adaptive control and operation of segmentation in, for example, the MAC of an E-UTRAN system that provides support for the aforementioned operations.

In accordance with the exemplary embodiments of this invention, assume that the system supports adaptive MAC packet segmentation and transmission, including the exemplary operational options discussed above in regards to the exemplary embodiments disclosed in the above-captioned commonly owned U.S. Provisional Patent Application, during the lifetime of a given active logical channel, identified by a unique LCID. The non-limiting, exemplary operational options employed in the adaptive MAC packet segmentation are as follows:

Case 1: post-segmentation with variable sizes of SDUs and segments thereof, including the case of non-segmentation with variable SDU sizes;

Case 2: non-segmentation with a fixed SDU size for applications such as VoIP; and

Case 3: pre-segmentation with a semi-static segment size.

The exemplary embodiments of this invention focus on protocol aspects of MAC including the signaling method and data structures that enable the aforementioned adaptive MAC packet segmentation and transmission operations.

In accordance with the exemplary embodiments of this invention there is provided an adaptive control type of MAC Control PDU (C-PDU) which is user-specific, and that is originated and terminated in the MAC. This C-PDU is sent whenever there is a need to switch between the above Cases 1-3, or to change the value of semi-static parameters such as the fixed size of SDU segments for the given LCID. This C-PDU contains any necessary control information, such as the next adaptive control scheme to be used (Case 1, 2 or 3) and the size index indicating the semi-static length of SDUs (in Case 2) or segments thereof (in Case 3) for one or several active LCIDs of the same UE 10, as non-limiting examples. It is reasonable to assume that this C-PDU is not required to be transmitted often during the life time of the given LCID, and thus does not result in a significant increase in the control overhead.

Further, Cases 1-3 all use the same basic data structure(s) and only the SDU segment header structure may be different between the Cases.

Case 1 may be considered as a default operational mode or option. The C-PDU described above can be used, for example, to inform the receiving entity of the related LCID that there is to be a change in the outer ARQ operation, such as switching between operating on complete SDUs and operating on segments thereof.

Case 2 is applied after the C-PDU described above is communicated for indicating the fixed size of SDUs to the receiver. In the SDU segment header structure, the length and segmentation control-related fields may be removed from the SDU segment header. For those logical channels used for certain transmissions, such as non-acknowledgment-mode VoIP, the SN field length may be deduced by the receiver and may be removed.

Case 3 is applied after the above C-PDU is communicated for indicating to the receiver the fixed size of segments that is in effect. In the SDU segment header structure, the SN field is understood as the SN of segments of SDUs. The length field is included if padding is required for the last segment of a SDU or for a complete small SDU; otherwise it may be removed.

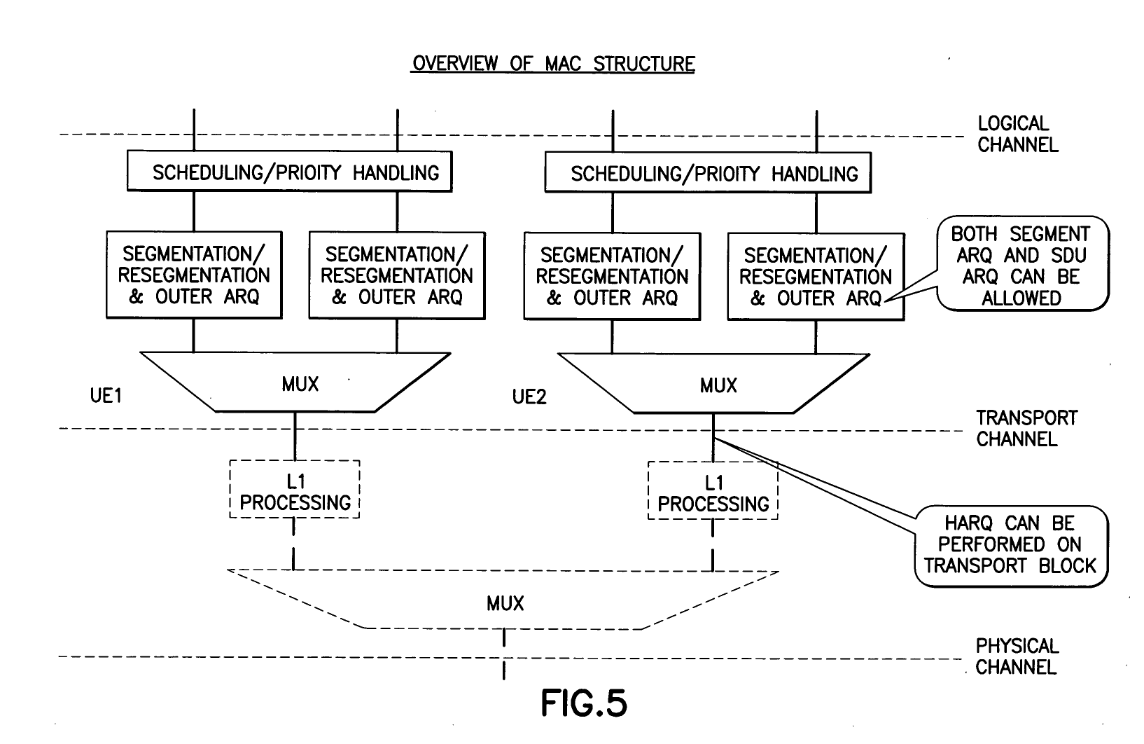

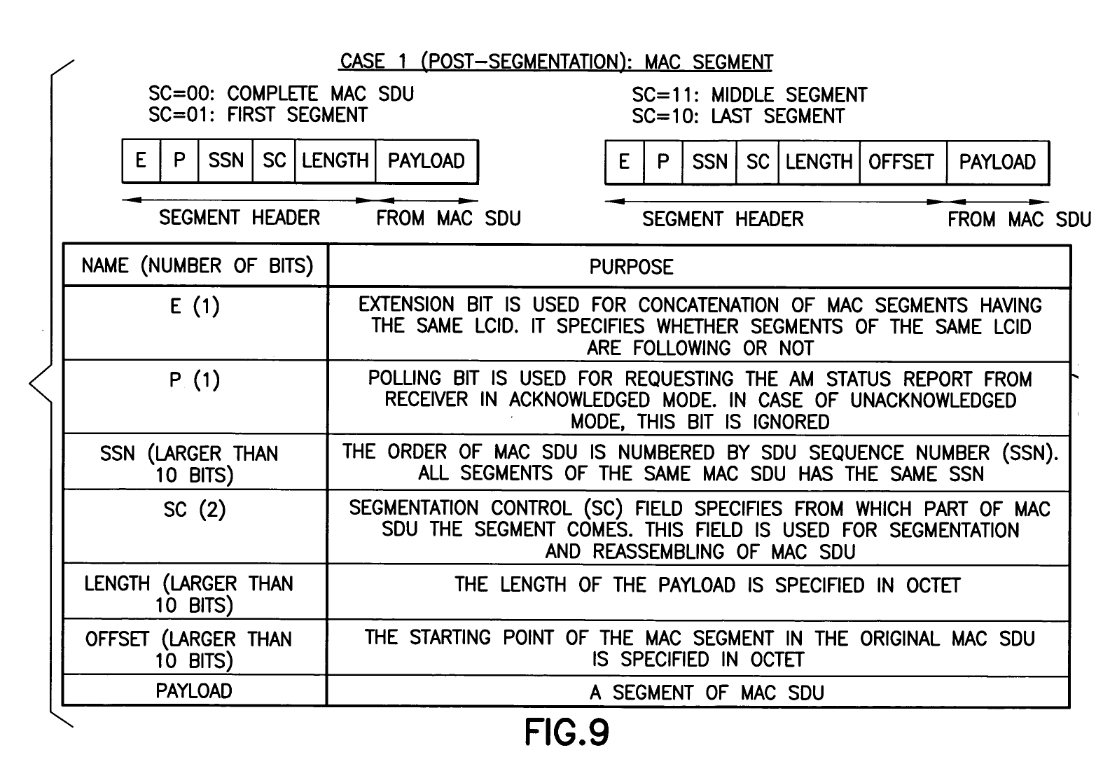

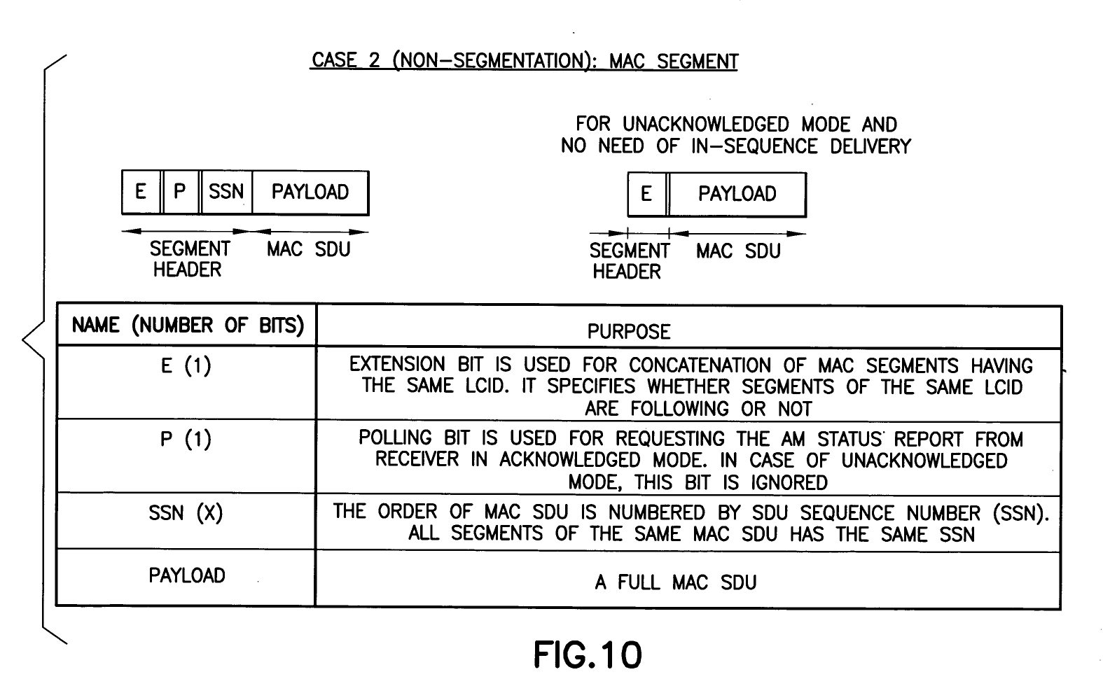

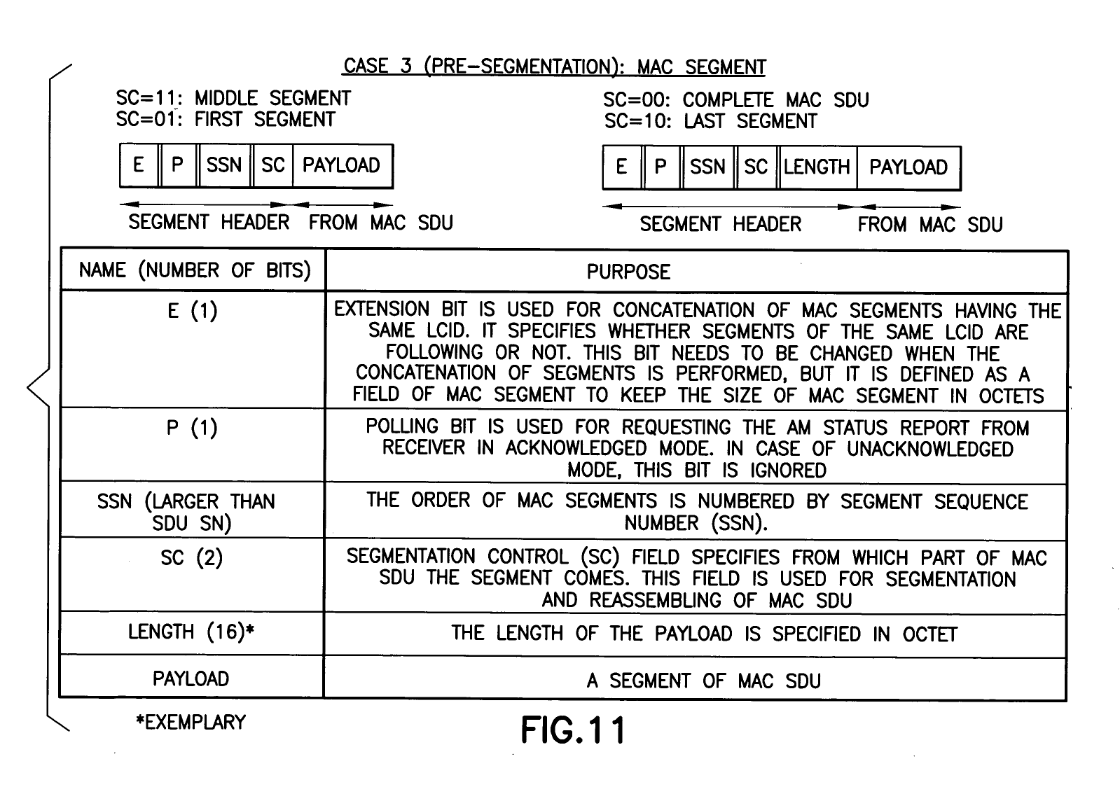

As an exemplary implementation, the basic MAC and data structure, which are common to Cases 1-3, is shown in FIG. 4, and in FIG. 5, 6, 7 and 8, while different exemplary SDU segment structures for Cases 1-3, in accordance with the exemplary embodiments of this invention, are shown in FIGS. 9, 10 and 11.

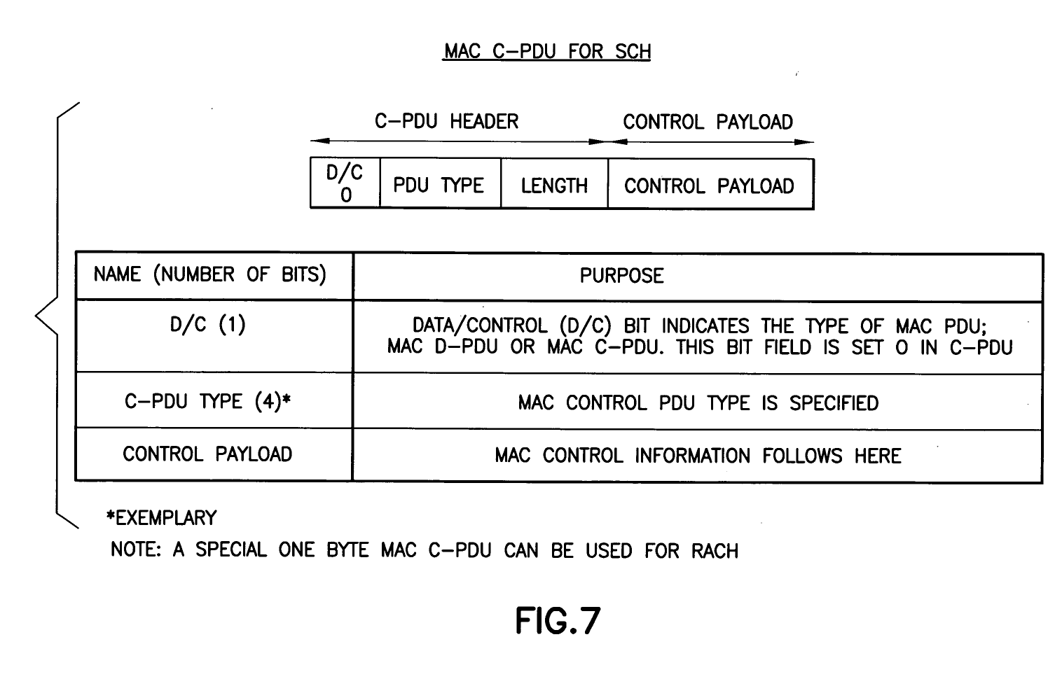

Note that in other embodiments, the type information shown in the C-PDU of FIG. 7 may be configured to indicate the next adaptive control scheme to be used.

The C-PDU in accordance with the exemplary embodiments of this invention may be concatenated with a first data PDU (D-PDU) of the LCID using the current TB concatenation structure as shown in the Figures. The first D-PDU is sent following the C-PDU in accordance with the exemplary embodiments with a modified data structure due to the effect of the C-PDU. In an error-free transmission of that TB, the receiver is able to decode the C-PDU first and use the control information immediately to decode the D-PDU of the LCID in effect. This allows for the adaptive control to take effect with minimum delay on the first packet.

The sender is preferably acknowledged that the C-PDU and the first D-PDU, sent according to the exemplary embodiments of this invention, is transmitted successfully before sending further packets. This may be achieved by using, for example, an explicit C-PDU from the receiver and/or a local lower-level HARQ indication of the transmission status of the TB which contains the C-PDU to be acknowledged. The use of such in-band signaling is thus significantly faster than using higher-level RRC control signaling for the same purpose.

To ensure robustness for this operation, the exemplary embodiments of this invention provide at least two solutions.

Solution 1: A “starting time” is defined and the control message is resent if the sender does not receive the acknowledgement before the starting time. The new control message will have a new starting time. The acknowledgement preferably returns the starting time to identify which control message was acknowledged.

Solution 2: The control message is sent in every transport block and the new message format is placed into use immediately. The messages in the reverse direction use the current (old) format. When the acknowledgement is received, the sender stops sending the control messages, and the reverse direction begins using the new format starting from the transport block containing the acknowledgement. The acknowledgements are preferably repeated so long as the reverse sender sees that the first transmitter has stopped sending the control messages. This may be recognized as being a full handshake protocol that ensures correct message flow operations. However, this solution may be more suitable for use in the case that the formats are not often changed. In the above, the control message is the same as the adaptive-control C-PDU.

It can be noted that the use of one or both of these solutions facilitates enhancing the robustness of the C-PDU signaling between the transmitter and the receiver. This is an important feature, since the loss of a control message may lead to a situation wherein, for example, the receiver assumes the use of a different header format than is actually used by the transmitter. Were this to occur, the communication between the transmitter and receiver may likely be detrimentally affected.

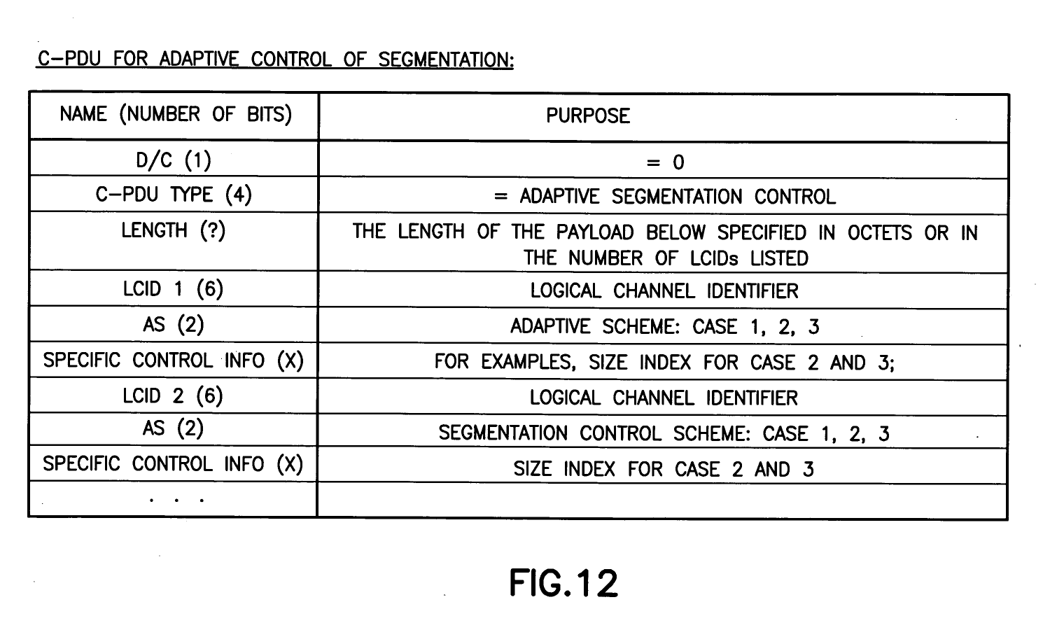

In addition to the generic data structures shown in the Figures, with modifications to and possible removals of one or more control fields as described above, exemplary and non-limiting embodiments of the C-PDUs in accordance with the exemplary embodiments of this invention, i.e., the C-PDU for adaptive control of segmentation and the C-PDU for acknowledging receipt of the C-PDU, are shown in FIGS. 12 and 13, respectively.

The exemplary embodiments of this invention, using the C-PDUs of FIGS. 12 and 13, the adaptable data structures and adaptive segmentation, may be applied for a given LCID during its lifetime for achieving an efficient system implementation and performance (at least in terms of efficient hardware and software implementations adapted to platform capabilities and in terms of reducing protocol overhead).

The exemplary embodiments of this invention, using the C-PDUs of FIGS. 12 and 13, coupled with the current TB concatenation structure shown in the Figures allows for the adaptive segmentation control to become effective with minimum delay.

Further, and assuming a case where there are no dynamic changes of the segment structure during the LCID lifetime, the use of the exemplary embodiments of this invention permits the E-UTRAN to use the most efficient header structure for the traffic associated with the LCID.

Still further, it should be appreciated that the use of the exemplary embodiments of this invention provides a MAC functionality that is efficient, flexible and robust, and that does not require significant changes in the existing MAC structures and procedures proposed for use in E-UTRAN, and that furthermore is capable of unifying various options under discussion in 3GPP for E-UTRAN.

Note that the exemplary embodiments of this invention can be used in the DL and in the UL.

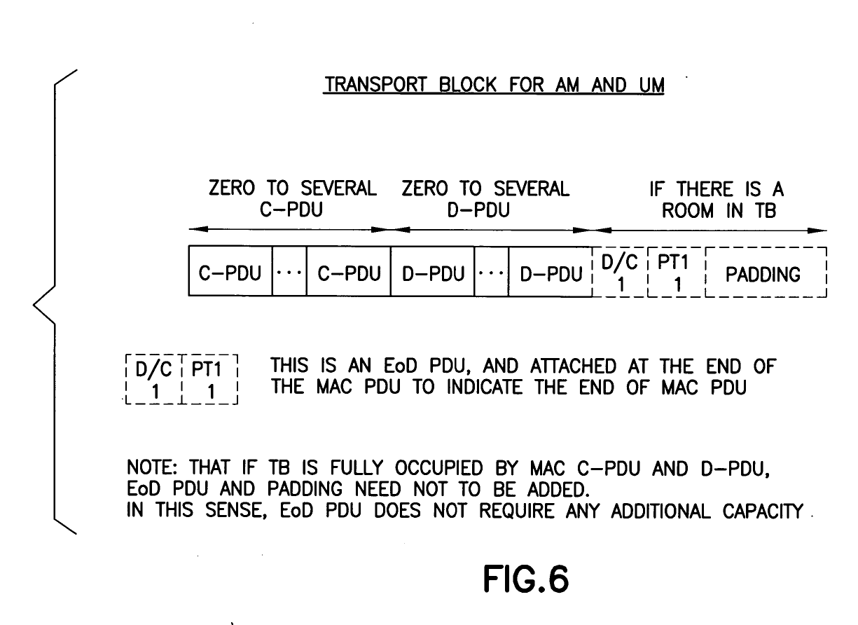

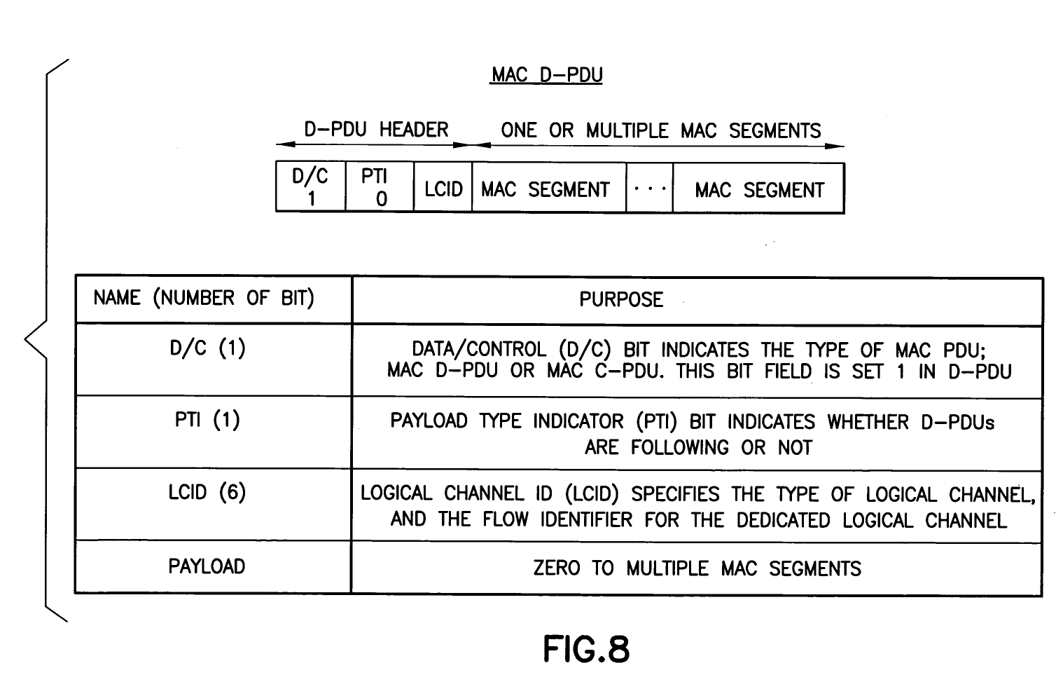

It should be further noted that the numbers of bits shown in the various fields of the messages and structures depicted in FIGS. 6, 7, 8, 9, 10, 11, 12 and 13, whether expressly indicated as being exemplary or not, are all intended to be viewed as being exemplary, and in no way should be viewed as imposing any type of limitation on the use or practice of the embodiments of this invention. Further, those bit indications marked as “x”, e.g., Length(x) in FIGS. 12 and 13, are intended to be viewed as containing any suitable number of bits needed to convey the required information. Still further, more or less than the indicated number of message fields may be used.

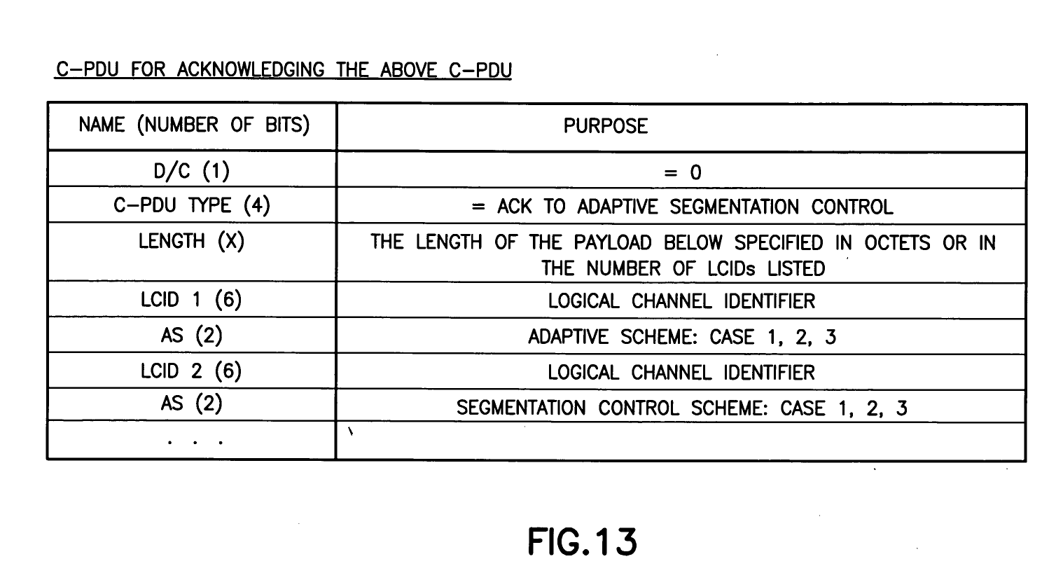

FIG. 14 depicts a flowchart illustrating one non-limiting example of a method for practicing the exemplary embodiments of this invention. The exemplary method includes: determining, during an ongoing wireless communication, that a current communication scheme is to be changed to a new communication scheme comprising one of a new segmentation scheme or a new non-segmentation scheme (box 601); and sending a control protocol data unit (C-PDU) from a first device to a second device, wherein the C-PDU comprises identification information identifying the new communication scheme and control information related to the new communication scheme (box 602).

In other embodiments, the exemplary method shown in FIG. 14 may comprise one or more other aspects of the exemplary embodiments of the invention as further described herein.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

While the exemplary embodiments have been described above in the context of an E-UTRAN system, it should be appreciated that the exemplary embodiments of this invention are not limited for use with only this one particular type of wireless communication system, and that they may be used to advantage in other wireless communication systems.

Furthermore, although the exemplary embodiments have been described above in the context of a MAC C-PDU and MAC signaling, it should be appreciated that the exemplary embodiments of this invention are not limited for use with only this one particular layer of communication protocol, and that they may be used to advantage in other layers and signaling.

In general, the various embodiments maybe implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein maybe implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
determining, during an ongoing wireless communication, that a current communication scheme is to be changed to a new communication scheme comprising one of a new segmentation scheme or a new non-segmentation scheme; and
sending a control protocol data unit (C-PDU) from a first device to a second device, wherein the C-PDU comprises identification information identifying the new communication scheme and control information related to the new communication scheme.

2. The method of claim 1, wherein the C-PDU comprises a medium access control (MAC) C-PDU.

3. The method of claim 2, wherein the C-PDU is sent from a MAC layer of the first device and received by a MAC layer of the second device.

4. The method of claim 1, wherein the current scheme comprises one of a current pre-segmentation scheme, a current post-segmentation scheme or a current non-segmentation scheme, wherein the new scheme comprises one of a new pre-segmentation scheme, a new post-segmentation scheme or a new non-segmentation scheme.

5. The method of claim 4, wherein the current scheme comprises the current non-segmentation scheme, wherein the new scheme comprises the new non-segmentation scheme, wherein the control information comprises a new value for at least one semi-static parameter.

6. The method of claim 5, wherein the new value comprises a new size index indicating a new semi-static length of service data units.

7. The method of claim 4, wherein the current scheme comprises the current pre-segmentation scheme, wherein the new scheme comprises the new pre-segmentation scheme, wherein the control information comprises a size index indicating a length of segments.

8. The method of claim 4, wherein the new scheme comprises the new post-segmentation scheme, wherein the control information comprises information for an outer ARQ operation indicating a switch between operating on complete service data units and operating on segments of service data units.

9. The method of claim 1, further comprising:
concatenating the C-PDU with a data protocol data unit (D-PDU), wherein the D-PDU utilizes the new scheme.

10. The method of claim 1, further comprising:
in response to receiving the C-PDU, sending an acknowledgement from the second device to the first device.

11. The method of claim 10, wherein the C-PDU comprises a first C-PDU, wherein the acknowledgement comprises at least one of a second C-PDU and/or a local lower-level hybrid automatic request/acknowledge indication of a transmission status of the first C-PDU.

12. The method of claim 10, wherein the C-PDU comprises a first C-PDU, the method further comprising:
defining a first start time for the first C-PDU;
in response to the first device not receiving the acknowledgement before the first start time, sending a second C-PDU from the first device to the second device; and
defining a second start time for the second C-PDU.

13. The method of claim 12, wherein the first C-PDU comprises the first start time, wherein the acknowledgement sent in response to receiving the first C-PDU comprises the first start time.

14. The method of claim 10, wherein the C-PDU is sent in every transmission from the first device to the second device until an acknowledgement is received by the first device from the second device.

15. The method of claim 14, wherein the acknowledgement is sent in every transmission from the second device to the first device until the C-PDU is not received by the second device.

16. The method of claim 1, wherein the C-PDU comprises identification information and control information for a plurality of logical channels of the ongoing communication.

17. The method of claim 1, wherein the first device and the second device comprise nodes in an evolved UMTS terrestrial radio access network.

18. The method of claim 1, wherein the first device comprises a mobile node and wherein the second device comprises a base station.

19. The method of claim 1, wherein the first device comprises a base station and wherein the second device comprises a mobile node.

20. A computer program product comprising program instructions embodied on a tangible computer-readable medium, execution of the program instructions resulting in operations comprising:
determining, during an ongoing wireless communication, that a current communication scheme is to be changed to a new communication scheme comprising one of a new segmentation scheme or a new non-segmentation scheme; and
sending a control protocol data unit (C-PDU) from a first device to a second device, wherein the C-PDU comprises identification information identifying the new communication scheme and control information related to the new communication scheme.

21. The computer program product of claim 20, execution of the program instructions resulting in operations further comprising:
in response to receiving the C-PDU, sending an acknowledgement from the second device to the first device.

22. The computer program product of claim 21, wherein the C-PDU comprises a first C-PDU, execution of the program instructions resulting in operations further comprising:
defining a first start time for the first C-PDU;
in response to the first device not receiving the acknowledgement before the first start time, sending a second C-PDU from the first device to the second device; and
defining a second start time for the second C-PDU.

23. The computer program product of claim 22, wherein the first C-PDU comprises the first start time, wherein the acknowledgement sent in response to receiving the first C-PDU comprises the first start time.

24. The computer program product of claim 21, wherein the C-PDU is sent in every transmission from the first device to the second device until an acknowledgement is received by the first device from the second device.

25. The computer program product of claim 24, wherein the acknowledgement is sent in every transmission from the second device to the first device until the C-PDU is not received by the second device.

26. The computer program product of claim 20, wherein the C-PDU comprises a medium access control C-PDU.

27. The computer program product of claim 20, wherein the first device and the second device comprise nodes in an evolved UMTS terrestrial radio access network.

28. An electronic device comprising:
a transceiver configured to wirelessly communicate with another electronic device; and
a data processor coupled to the transceiver, wherein the data processor is configured to determine, during an ongoing wireless communication with a second device, that a current communication scheme is to be changed to a new communication scheme comprising one of a new segmentation scheme or a new non-segmentation scheme; and sending a control protocol data unit (C-PDU), using the transceiver, to the second device, wherein the C-PDU comprises identification information identifying the new communication scheme and control information related to the new communication scheme.

29. The electronic device of claim 28, wherein the C-PDU comprises a medium access control C-PDU.

30. The electronic device of claim 28, wherein the electronic device comprises anode in an evolved UMTS terrestrial radio access network.

31. The electronic device of claim 28, wherein the electronic device comprises a mobile node.

32. The electronic device of claim 28, wherein the electronic device comprises a base station.

33. A protocol data unit structure embodied on a tangible readable medium, the protocol data unit structure comprising:
D/C information configured to indicate that the protocol data unit structure comprises a control protocol data unit (C-PDU);
new scheme identification configured to indicate a new communication scheme for ongoing wireless communication, wherein the new communication scheme comprises one of a new segmentation scheme or a new non-segmentation scheme; and
a control payload comprising control information for the new communication scheme.

34. The protocol data unit structure of claim 33, further comprising:
a length of the control payload.

35. The protocol data unit structure of claim 34, wherein the length is indicative of one of a number of octets of the control payload or a number of logical channels of the control payload.

36. The protocol data unit structure of claim 33, wherein the D/C information is configured to indicate that the protocol data unit structure comprises a medium access control C-PDU.
